(19) United States
(12) Patent Application Publication
(10) Pub. No.: US 2014/0122245 A1
(43) Pub. Date: May 1, 2014

(54) METHOD FOR AUDIENCE PROFILING AND AUDIENCE ANALYTICS

(71) Applicant: SHARE THIS INC., Palo Alto, CA (US)

(72) Inventors: Yan Qu, Los Altos, CA (US); Nanda Kishore, Los Altos, CA (US); Andrew Stevens, New York, NY (US); Ramanathan Ramaswamy, San Ramon, CA (US); Manu Mukerji, Sunnyvale, CA (US); Seungjoon Lee, Hayward, CA (US); Vivin Williams, Palo Alto, CA (US)

(21) Appl. No.: 13/661,905

(22) Filed: Oct. 26, 2012

(51) Int. Cl. G06Q 30/02

(52) U.S. Cl. CPC G06Q 30/0269
USPC 705/14.66

(57) ABSTRACT

Embodiments of a method for generating reports are illustrated. In an embodiment, the method includes receiving a log record from a tracking component that is located on a plurality of web pages. The method includes extracting a plurality of user features for a plurality of users based on the at least one log record. The method further includes determining a first mapping between the plurality of users and a plurality of user features, and a second mapping between the plurality of users and a plurality of advertisement campaign descriptors. The method also includes merging the first mapping and the second mapping to create a merged data model, and analyzing the merged data model to generate reports.

### TECHNICAL FIELD

The present disclosure relates, in general, to an audience analytics and audience profiling system. More specifically, the present disclosure relates to an analysis and profiling system used to create reports and user profiles of a target audience.

### BACKGROUND

The Internet allows for mass global exchange of information and data amongst millions of users across private, public, academic, business, commercial and government networks. The Internet has facilitated an explosive growth in e-commerce in recent years. Therefore, for commercial reasons, it may be desirable in certain scenarios to know more about internet users.

### SUMMARY

Embodiments of a method for generating a plurality of reports regarding a plurality of users visiting a plurality of web pages. The method extracts one or more user features for each of the plurality of users based on at least one log record. The method then determines a first mapping between the plurality of users and one or more user features. A second mapping is determined between the plurality of users and a plurality of advertisement campaign descriptors. The method then merges the first mapping and the second mapping to create a merged data model. Redundant records, if any, are removed from the merged data model. The resulting data model is analyzed for generating one or more reports.

### BRIEF DESCRIPTION OF DRAWINGS

The following detailed description of the embodiments of the disclosed invention will be better understood when read with reference to the appended drawings. The invention is illustrated by way of example, and is not limited by the accompanying figures, in which like references indicate similar elements.

FIG. 1 illustrates a system environment in which the present disclosure can be implemented, in accordance with an embodiment;

FIG. 2 illustrates an exemplary system diagram showing various modules of a web analytic server, in accordance with an embodiment;

FIG. 3 illustrates a flowchart for generating a report, in accordance with an embodiment of the disclosure;

FIG. 3A illustrates a plurality of statistics computed by an analysis module, in accordance with an embodiment;

FIG. 3B illustrates another exemplary statistics chart computed by the analysis module, in accordance with an embodiment;

FIG. 3C illustrates another exemplary statistics chart computed by the analysis module, in accordance with an embodiment;

FIG. 4 illustrates a plurality of reports at a plurality of stages of an advertisement campaign, in accordance with an embodiment;

FIG. 4A illustrates a plurality of reports generated during request-for-proposal (RFP) stage of an advertising campaign, in accordance with an embodiment;

FIG. 4B illustrates a plurality of reports generated during pre-campaign stage, in accordance with an embodiment;

FIG. 4C illustrates a plurality of reports generated during post-campaign stage, in accordance with an embodiment;

FIG. 5 illustrates an exemplary report depicting share distribution of an advertisement campaign category, in accordance with an embodiment;

FIG. 6 illustrates another exemplary request for report depicting an earned media profile, in accordance with an embodiment;

FIG. 7 illustrates another exemplary report depicting a product/brand comparison index, in accordance with an embodiment;

FIG. 8 illustrates a statistical report of the different events types and descriptors across various content categories, in accordance with an embodiment;

FIG. 9 illustrates a distribution report showing probabilistic measure of event occurrence across the various content categories, in accordance with an embodiment;

FIG. 10 illustrates an exemplary post-campaign stage report depicting viewer/segment lift (or conversion), in accordance with an embodiment;

FIG. 11 illustrates search keywords and corresponding metrics, in accordance with an embodiment;

FIG. 12 illustrates share keywords and corresponding metrics, in accordance with an embodiment;

FIG. 13 illustrates share response keywords and corresponding metrics, in accordance with an embodiment;

FIG. 14 illustrates an exemplary advertisement campaign descriptor report, in accordance with an embodiment.

### DETAILED DESCRIPTION

The present disclosure can be best understood when read with reference to the detailed figures and description set forth herein. Various embodiments are discussed below with reference to the figures. However, those skilled in the art will readily appreciate that the detailed description given herein with respect to these figures is just for explanatory purposes as disclosed methods and systems extend beyond the described embodiments. For example, those skilled in the art will appreciate that, in light of the teachings presented, multiple alternative and suitable approaches can be recognized, depending on the needs of a particular application, to implement the functionality of any detail described herein.

### DEFINITION OF TERMS

Advertisement campaign: An advertisement campaign corresponds to a sequence of advertisement messages based on a product or a service which make up an integrated marketing communication. It is evident to a person skilled in the art that the advertisement campaign may also be referred to simply as a campaign.

Advertisement Campaign Descriptors: Advertisement campaign descriptors correspond to information/descriptions related to an advertisement campaign, and include, but are not limited to, a plurality of keywords associated with the advertising campaign, converted users, unconverted users, user's behavioral response descriptors, a social optimization pixel or retargeting pixel on a web page hosted by an advertising server, a set of target descriptors, and at least one content category associated with the advertisement campaign. The advertisement campaign descriptors may also include, but are not limited to, the name of the advertisement campaign, an audience segment targeted by the advertisement campaign, viewer names, advertisement impressions, clickers, clicks, visitor names, number of visits matched visitors, matched visits, a plurality of keywords describing the advertisement campaign users, users visiting the advertisement campaign but not converting into customers, user's behavioral response descriptors, or at least one content category associated with the campaign. The advertisement campaign descriptors may further include anything related to an advertisement campaign, such as a set of keywords or topics describing the campaign, content categories associated with the campaign, user response history including ad views, ad clicks, visits to the advertiser's web site (retargeting), and conversions on the advertiser's web site.

Advertisement Campaign Model: An advertisement campaign model corresponds to a data structure that contains metadata associated with the advertisement campaign. The advertisement campaign model can comprise cookies obtained from log records corresponding to the plurality of users and advertisement campaign descriptors.

Advertisement Conversion: An advertisement conversion, for example “Click-through-conversion”, corresponds to a user viewing an advertisement on one or more web pages, clicking on it, and ultimately buying a product or service from the advertiser's store. “Click-through-conversion” is generally credited once it occurs. In another embodiment, advertisement conversion, for example “View-through-conversion”, can correspond to a user viewing an advertisement on one or a plurality of web pages, does not click on the advertisement, but later visits the advertiser's website and makes a purchase. Generally, only the last advertisement view is credited with the “View-through-conversion” within a valid time period. The valid time period is specified by the advertisers, e.g., 7 days or 30 days. Beyond the valid time period, even if there is a match between an impression and a conversion, the impression is not considered to have any impact on the conversion.

Behavior: Behavior corresponds to an action performed by a user. Generally, a response of an individual or group to an action, environment, person, or stimulus corresponds to the behavior of the individual or group.

Ad Click: An ad click is an activity that ensues when a visitor interacts with an advertisement. This does not simply mean interacting with a rich media advertisement, but actually clicking through an online advertisement to the advertiser's destination. The click may also correspond to a click-through, in-unit click, and a mouse-over (e.g., mouse rollover, user rolls mouse over ad, and/or the like).

Ad Clicker: A user who clicks on an advertisement, such as a display banner ad.

Page Clicker: A page clicker corresponds to a user that performs the operation of clicking on a URL. For example, a clicker can click on the URL shared by a sharer on a web page. A clicker may be represented by a cookie.

Log Record: Log records are data received from a tracking component located on a web page. The log record is indicative of one or more activities of a plurality of users on each of the plurality of web pages. The log record may include, but is not limited to, an anonymous cookie representing one or more of the plurality of users, a click log, a sharing log, a timestamp, an event type, a sharing channel, a content identifier, a universal resource locator (URL), domain information and a browsing pattern of each of the plurality of users.

Publisher: A publisher corresponds to a group, organization, company or an individual responsible for originating a production of or maintaining a website. One publisher can own a single or multiple domain web servers or websites. Domain web servers, comprising a plurality of web pages, provide a location to place advertisements by an advertising server.

Segment: Segment corresponds to a class or segment of an audience. An advertisement campaign finely tuned to a segment of audience offers a higher response rate and a higher conversion rate. Targeting the advertisements to the appropriate audience segment enhances visitation and conversion rates of the users.

Sharer: A sharer corresponds to a user or a node that performs the operation of sharing information (e.g., a URL of a web page) with a plurality of users. A sharer may be represented by a cookie.

Share responder: A share responder corresponds to a user or a node that performs an operation of clicking on a URL shared by a sharer on a web page. In an embodiment, a clicker may correspond to a cookie representing a user. In most cases, the clicker performs the operation of clicking on a shortened URL of the URL that is shared by the sharer. A clicker may also be referred to as a share clicker.

Social Channel: A social channel corresponds to a website through which a sharing activity or a clicking activity occurs. For example, www.facebook.com represents the social networking channel, Facebook®.

Tracking component: A tracking component is a web-based component that is part of a web page configured to gather/collect log records. The log records facilitate tracking of user activity. The tracking component captures online activity of a user on the web page. Examples of the tracking component may include, but are not limited to, a widget, a button, a social optimizing pixel, a retargeting pixel, a hypertext, and a link on each of the plurality of web pages corresponding to the plurality of domain owners.

Tracking Application: A tracking application corresponds to a software application, which when installed on a web server results in an embedded tracking component in a web page hosted by the web server.

Retargeting Pixel: Retargeting pixel corresponds to a tracking component. The retargeting pixel is generally placed on a plurality of landing web pages of an advertiser's website. The retargeting pixel may be used interchangeably with an “invisible pixel” or a “one-by-one image request” or a “retargeting tag”. When the user activates the retargeting pixel by visiting the web page on which the pixel is residing, a cookie may be placed in the user's browser's cache so that the advertiser can recognize the user when he/she visits other sites in the network at a later time.

Retargeting Log Records: Retargeting log records are received from a tracking component (e.g. a retargeting pixel) located on a web page. A retargeting log record may comprise a cookie, timestamp, the label of the retargeting pixel, and/or the URL of the web page.

User Activity: A user activity corresponds to activities performed by the user on a plurality of web pages. Examples of user activities include, but are not limited to, sharing through a tracking component, viewing a web page, clicking a web link, visiting a web page or searching for a keyword, opening the tracking application, clicking on an ad displayed on a plurality of web pages, or conducting online transactions on a web page. The user activities are stored as user activity data that has users represented as cookies.

User Interest: User interest may be inferred from online activities performed by the user on a web page. For example, interests of a user may be determined from a content category of a web page (e.g., news, sports, music, stock market, cartoons etc.) on which one or a plurality of online activities is performed.

User Features: User features comprise a plurality of attributes associated with the user. The user features may be one of, but not limited to, the content category associated with the at least one web page, keywords representing the user's interest, share keywords, share response keywords, search keywords or total number of visits of the user to the at least one web page.

User Model: A user model corresponds to a data structure comprising a mapping between a user and the event type(s) inferred from online activities of the user, and/or user features corresponding to the user. The user features may comprise a content category associated with the at least one web page the user visited, keywords representing the user's interest, sharing activity of the user or total number of visits of the user to the at least one web page. Users can be represented by anonymous cookies.

Page Viewer: A page viewer corresponds to a user who is visiting one or more web pages of one or more domain web servers.

Ad Viewer: An ad viewer corresponds to a user who is exposed to ads on the web pages placed by the advertising server on domain web servers.

Visitors: Visitors include number of users visiting a specific website. A unique visitor count depicts how many different users there are in the audience during a specific time period (for example 30 days) as per an embodiment of the disclosure.

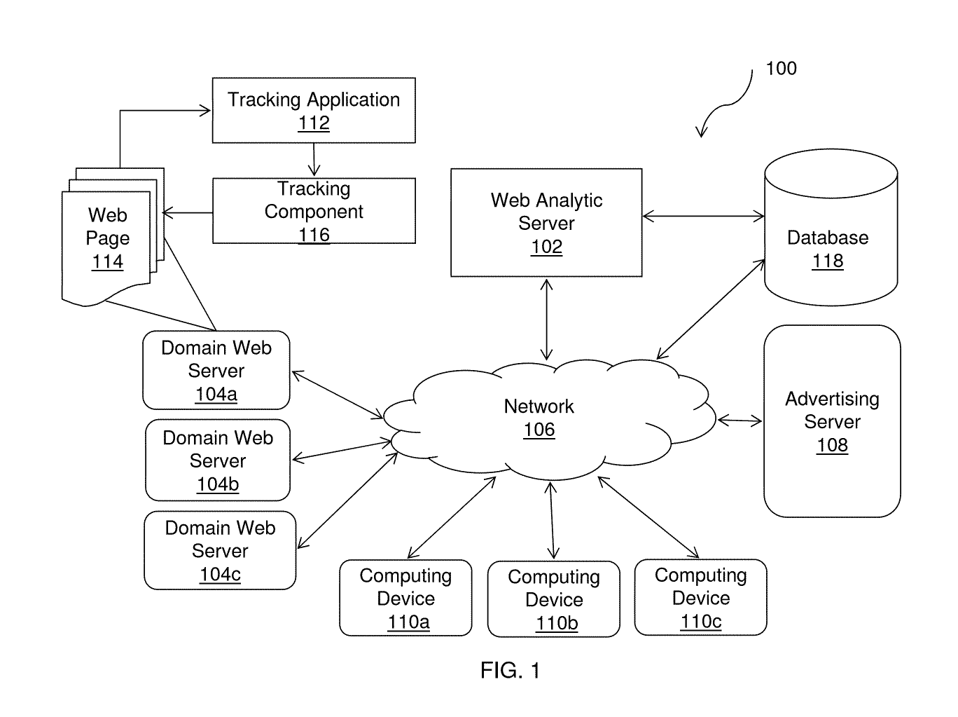

FIG. 1 illustrates a system environment 100 in which the present disclosure can be implemented. The system environment 100 includes a web analytic server 102, a plurality of domain web servers 104a, 104b and 104c (hereinafter, referred to as domain web server 104), a network 106, and an advertising server 108. The system environment 100 further includes a plurality of computing devices 110a, 110b and 110c (hereinafter, referred to as computing device 110), and a database 118 connected with the web analytic server 102 and the network 106.

In an embodiment, a web analytic server 102 corresponds to a web analytic system having capabilities to extract and analyze data for commercial purposes by using a plurality of analytic tools. The analytical tools may include, but are not limited to, a tracking tool, a social behavior analytic tool, a target audience analytic tool, audience segmentation tool, user modeling, campaign analytics, and campaign optimization tool. Further, the web analytic server 102 may extract data using various languages, such as, Structured Query Language (SQL), 4D Query Language (4DQL), Object Query Language (OQL), and Stack Based Query Language (SBQL). Typical examples of a web analytic server include a general-purpose computer, a programmed microprocessor, a micro-controller, a peripheral integrated circuit element, and other devices or arrangements of devices that are capable of implementing steps that constitute the method of the present disclosure.

The domain web server 104 includes a data storage system that has the capability of storing information corresponding to a plurality of domain owners. In an embodiment, the domain web server 104 hosts one or more of a plurality of web pages 114. Examples of the plurality of domain owners include Stumble Upon® and Constantcontac®, forbes.com, or mashable.com.

In an embodiment, the domain web server 104 subscribes to the web analytic server 102 to receive one or more web analytics services. Such web analytic services may include share quality index analysis for domain ranking, social graph construction, social lookalike, influencer modeling, audience analytics, and path-to-conversion analysis. Preferably, each of the plurality of web pages includes the tracking component 116.

The domain web server 104 downloads a tracking application 112 from the web analytic server 102 and installs the tracking application 112 that results in a web page that includes one or more tracking components 116.

The network 106 corresponds to a medium through which content and messages flow between the various components (i.e., the plurality of computing devices 110a, 110b, and 110c, the web analytic server 102, the domain web server 104 and the advertising server 108) of the system environment 100. Examples of the network 106 may include, but are not limited to, a television broadcasting system, an IPTV network, a Wide Area Network (WAN), a Local Area Network (LAN), a Metropolitan Area Network (MAN) or Wireless Fidelity (Wi-Fi) network. Various devices in the system environment 100 can connect to the network 106 in accordance with various wired and wireless communication protocols such as Transmission Control Protocol and Internet Protocol (TCP/IP), User Datagram Protocol (UDP), and 2G, 3G or 4G communication protocols.

The advertising server 108 is a computer server that stores advertisements and delivers them to the users determined to be appropriate for advertisers' campaigns by the web analytic server 102. Remotely located advertising servers send advertisements across multiple domain web servers 104a, 104b and 104c, owned by multiple publishers. In an embodiment, the advertising server 108 may deliver advertisements from one central source so that advertisers and publishers can track the distribution of their online advertisements, and have one location for controlling the rotation and distribution of their advertisements across the network. Each of the one or more domain web servers 104a, 104b and 104c comprises a plurality of web pages 114. Each of the web pages 114 comprises at least a tracking component 116 for tracking a user's online activity. The advertising server 108 can correspond to a web server hosting one or more advertisement domains (websites). For example, the advertising server 108 may host an online shopping website that offers one or more products or services. The advertising server 108 may include an advertising pool where the advertising campaigns may store their advertisement. The advertising server 108 may publish an advertisement to a group of domain web servers 104a, 104b and 104c based on the analysis performed by the web analytic server 102. Examples of advertising server 108, may include, but are not limited to, FTP server, HTTP server, mail server, and proxy server, and/or the like.

The computing device 110 includes one or more browsing applications that enable the user to browse through one or more web pages. The user provides a user input, for example, a keyword to navigate through the content on a plurality of publisher's web page. Although three computing devices 110a, 110b, and 110c have been shown in FIG. 1, it may be appreciated that the disclosed embodiments can be implemented through a large number of computing devices. The plurality of computing devices 110 corresponds to a plurality of users acting as a target and retarget audience in different embodiments of the present disclosure.

The database 118 corresponds to a storage device that stores data required to indicate relationships between the users, the user activities, the user behavior, the publishers, the advertisers, and the advertisement campaigns in a networked environment. For example, the database 118 can store information associated with a plurality of users, tracking data, user activity data, ad data, report data, publisher data, and content categorization data. The database 118 can be implemented by using several technologies that are well known to those skilled in the art. Some examples of technologies include, but are not limited to, MySQL® and Microsoft SQL®, Hive, Hbase, etc.

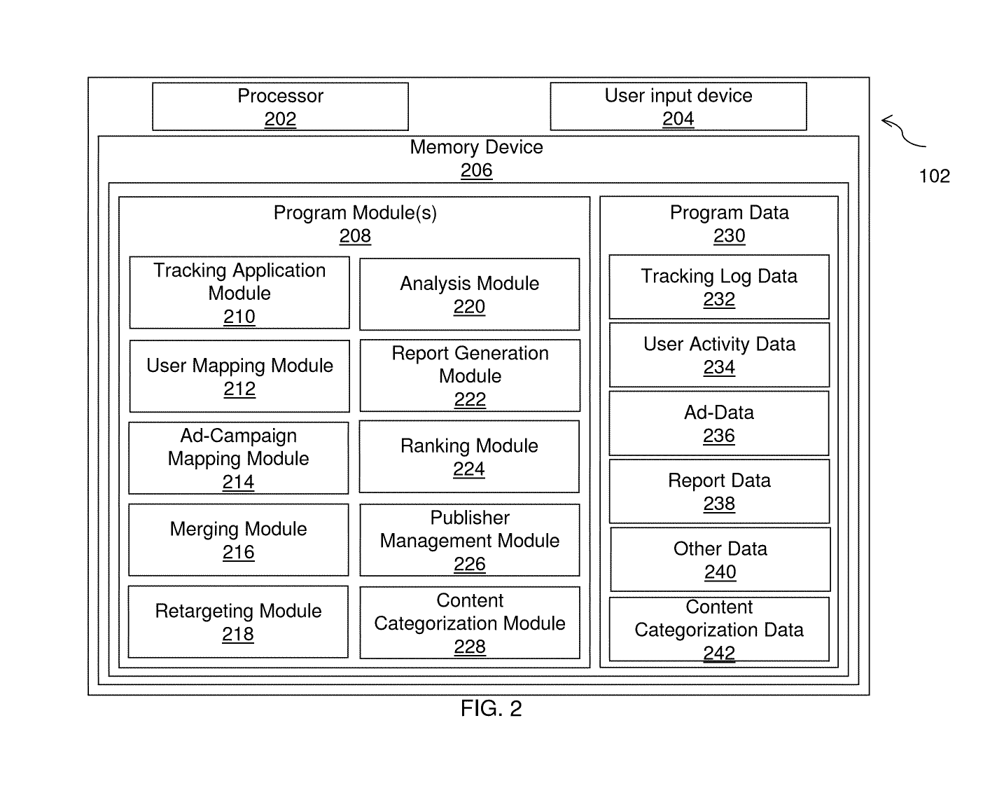

FIG. 2 illustrates an exemplary system diagram showing the various modules involved in a web analytic server 102, in accordance with an embodiment of the disclosure.

The web analytic server 102 includes a processor 202, a user input device 204 and a memory device 206. The processor 202 executes program module(s) 208 stored in the memory device 206. The processor 202 can be realized through a number of processor technologies known in the art. Examples of the processor 202 can be X86 processor, RISC processor, ASIC processor, CSIC processor, or any other processor.

The memory device 206 is configured to store program data 230 and the program modules(s) 208. The program module(s) 208 is configured to use the program data 230 for implementing various embodiments. Examples of the memory device 206 may include, but are not limited to, floppy disks, magnetic tapes, punched cards, hard disk drives, optical disc drives, and USB flash drives.

In an embodiment, the program data 230 stores data required to uncover the relationship between the users, the user activities, the user behavior, the publishers, the advertisers, and the advertisement campaigns in a networked environment. For example, the Program Data 230 can store tracking log data 232, user activity data 234, Ad-data 236, report data 238, other data 240, and content categorization data 242.

The tracking log data 232 corresponds to a data structure configured to store a plurality of log records corresponding to each of the plurality of users. The log records are generated as a result of one or more activities performed by the user. The one or more events comprises sharing through a tracking component 116, viewing a web page, clicking a web link, visiting a web page or searching for a keyword.

The user activity data 234 corresponds to a data structure configured to store the determined plurality of users, user features, user event types, and user model comprising the mapping between the plurality of users and their respective event types and features. In another embodiment, the user activity data 234 can comprise a plurality of users and their behaviors towards a plurality of advertisers' campaigns, in addition to the user model.

The ad-data 236 corresponds to a data structure configured to store a plurality of attributes associated with the plurality of advertisers and the plurality of advertisement campaign descriptors. In an embodiment, the Ad-data 236 also stores an intermediate data structure, such as an advertisement campaign mapping model. In another embodiment, the Ad-data 236 also stores the mappings between users and their views or clicks of advertising campaigns or their visits to and conversions on the advertisers' web sites.

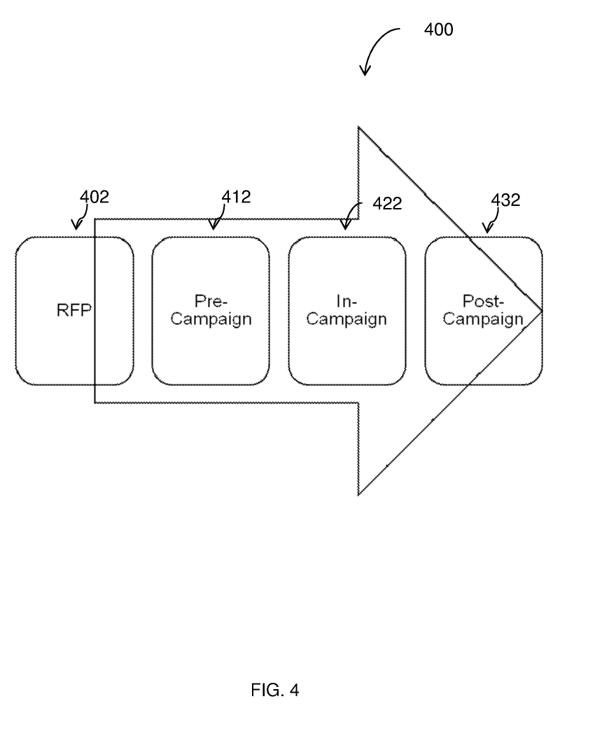

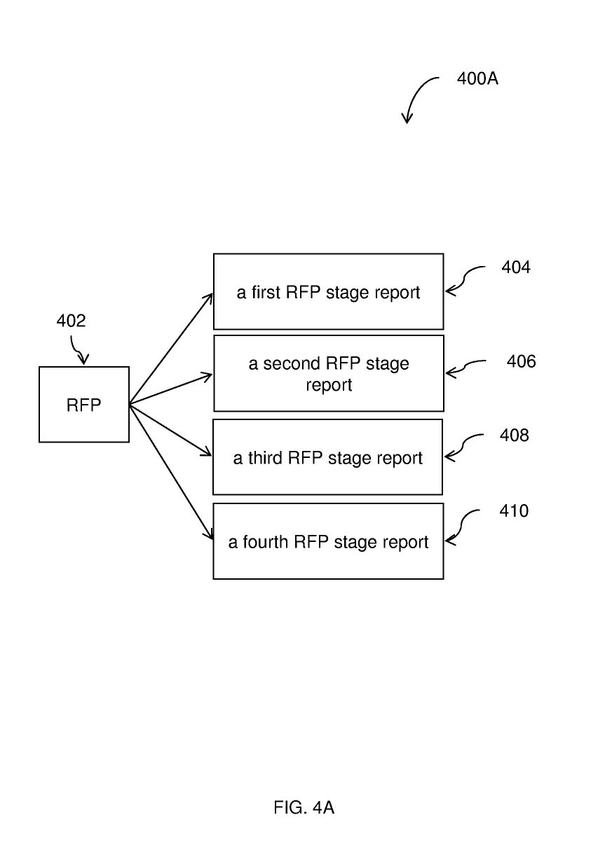

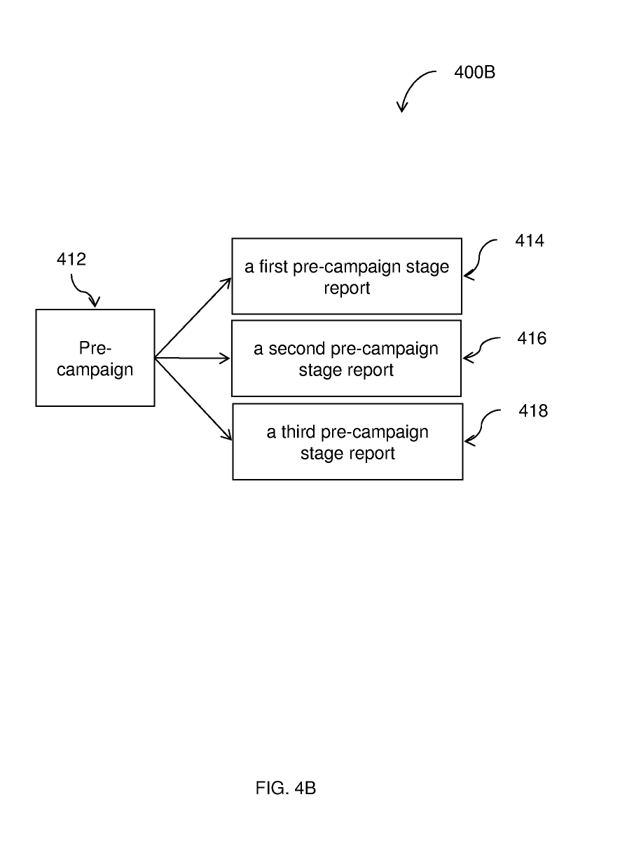

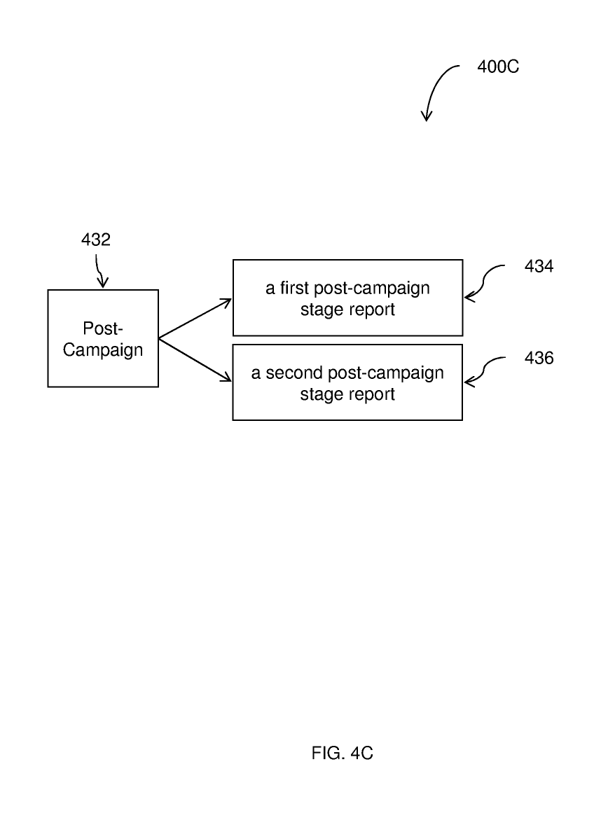

The report data 238 comprises one or more reports generated by a report generation module 222. The one or more reports can be retrieved by the advertising server 108 from the report data 238 during one or more stages of the advertisement campaign. In an embodiment, the one or more reports comprise a user profile report, a segment profile report, and a retarget user profile report. The plurality of reports at a plurality of stages is described in detail below with reference to FIG. 4.

The other data 240 comprises publisher data. The publisher data corresponds to a data structure configured to store a plurality of attributes associated with the plurality of publishers and domain web servers associated with each of the publishers.

The content categorization data 242 corresponds to a data structure configured to store categories of the content of preferably each of the plurality of web pages. In an embodiment, the categories are determined based on log records.

The program data 230 can be implemented by using several technologies that are well known to those skilled in the art. Some examples of technologies include, but are not limited to, MySQL®, Microsoft SQL®, and Apache Hadoop family (e.g. Hadoop®, Hive®, PIG® etc).

The program module(s) 208 store a set of instructions or modules which may include a tracking application module 210, user mapping module 212, Ad-campaign mapping module 214, merging module 216, retargeting module 218, analysis module 220, report generation module 222, ranking module 224, publisher management module 226, and content categorization module 228.

The tracking application module 210 is configured to provide the tracking application 112 to the plurality of domain owners on a subscription basis.

The user mapping module 212 determines a first mapping between preferably each of the plurality of users and the corresponding one or more user features. The user mapping module 212 fetches cookies (representing users) and event types corresponding to the users from the tracking log data 232, and content categories from the content categorization data 242, and derives user features (such as domains visited, URLs viewed, topics viewed, browser used, etc.) based on the user activities in the tracking log data 232 for creating a user model. The user mapping module 212 stores the user model in the user activity data 234. In an embodiment, the data for the first mapping is collected over a period of 30 days.

The ad-campaign mapping module 214 determines a second mapping between the user cookies fetched from tracking log data 232 and a plurality of advertisement campaign descriptors fetched from the ad-data 236 to create an advertisement campaign model. The advertisement campaign model is stored in the ad-data 236 by the ad-campaign mapping module 214.

The merging module 216 is configured to merge the user model and the advertisement campaign model for creating a merged data model. The merging module 216 fetches the user model from the user activity data 234 and the advertisement campaign data model from the ad-data 236. The merging module 216 then aggregates a plurality of records of the plurality of users, the user features and the advertisement campaign descriptors from the two data models to create a merged model. Thereafter, the merging module 216 removes redundant records from the aggregated records and stores the merged data model in the user activity data 234.

In an embodiment, the retargeting module 218 is configured to determine the mapping between a plurality of users and a plurality of advertisement campaign descriptors such as the retargeting pixels. The retarget data model is stored in the ad-data 236.

The analysis module 220 analyzes and segments the merged data model and then removes redundant data records, if any. In an embodiment, the analysis module 220 forms audience segments and stores an aggregate number value corresponding to each audience segment. In an embodiment, the aggregate number value is the count of unique user cookies in the associated segment. In another embodiment, the analysis module 220 analyzes and segments the retarget data model and removes redundant data records, if any. The analysis module 220 forms one or more retarget audience segments and stores an aggregate number value corresponding to each audience segment. The aggregate number value, in such an embodiment, is the count of unique user cookies in each segment.

The report generation module 222 is configured to generate a plurality of reports. The web analytic server 102 determines how to gain the most optimal use from the reports of the advertisers. The advertisers may use one or more reports to understand the interests and behaviors of the users by processing the user profiles through various analytical methods. The advertisers may also use the one or more reports for targeting content/search results, audience segmenting, retargeting user profiles, and personalizing content/search results. In an embodiment, the reports are generated for all stages of an advertisement campaign. The report generation module 222 stores the reports in the Report Data 238.

The ranking module 224 facilitates ranking of one or more audience segments based on one or more metrics. Such a ranking provides a measure of user profiles across various user features in each of the plurality of audience segments. The one or more metrics may comprise a number of users visiting one of the plurality of web pages, overall user traffic at the web page, a ratio of number of users visiting the web page for a search keyword to the total number of users visiting the web page, and a click-through rate. The one or more metrics may also correspond to percentile, percentage, click-through-rate, click propensity, conversion propensity, conversion rates, probability, page impressions, advertisement impressions, clicks, visits, unique visitors, path analysis, recency, frequency metrics and scoring metrics. For example, the click-through-rate of a user for a category reflects the probability that the user will select (“click on”) some content (e.g., advertisement, link, and/or the like.) associated with the category. In yet another example, the conversion rate for a user in a category reflects the probability that the user will buy/purchase a product or service associated with the category.

The publisher management module 226 is configured to manage a subscription of the domain web server 104. The publisher management module 226 stores the subscription information related to each of the plurality of domain owners.

The content categorization module 228 gathers data from the tracking log data 232 and categorizes the log records based on the content of preferably each of the plurality of web pages associated with the log records into one or more content categories. The categorized content is then stored in content categorization data 242.

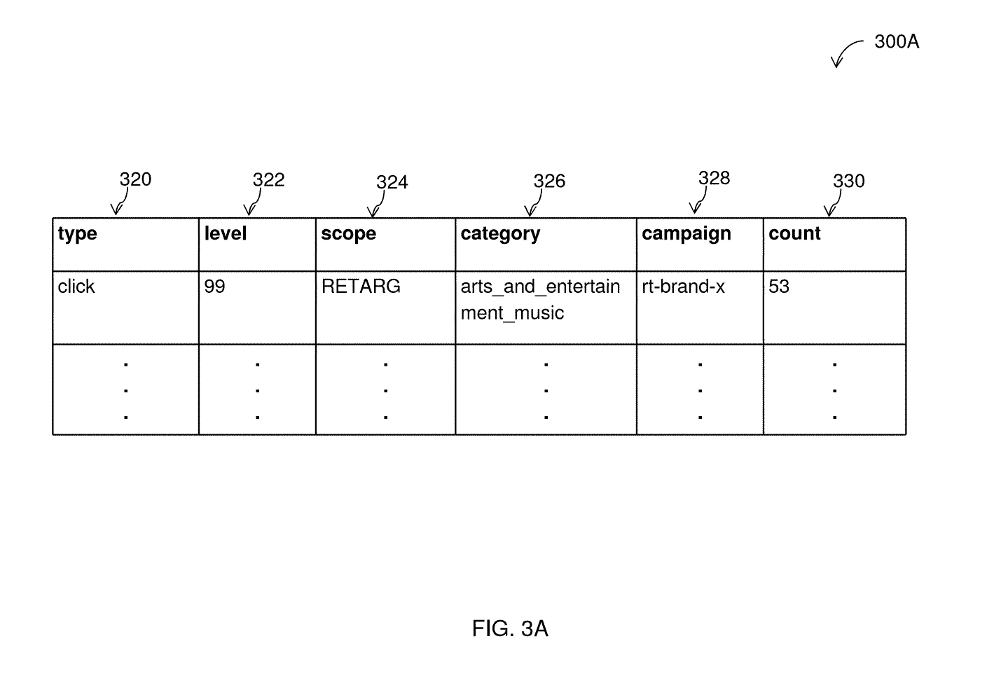

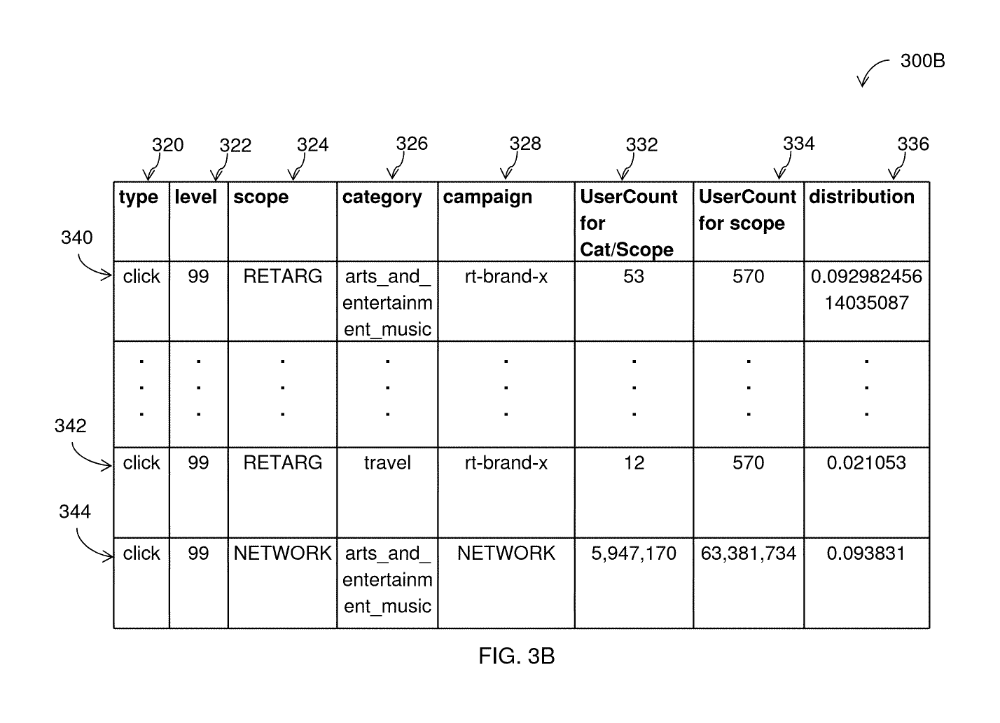

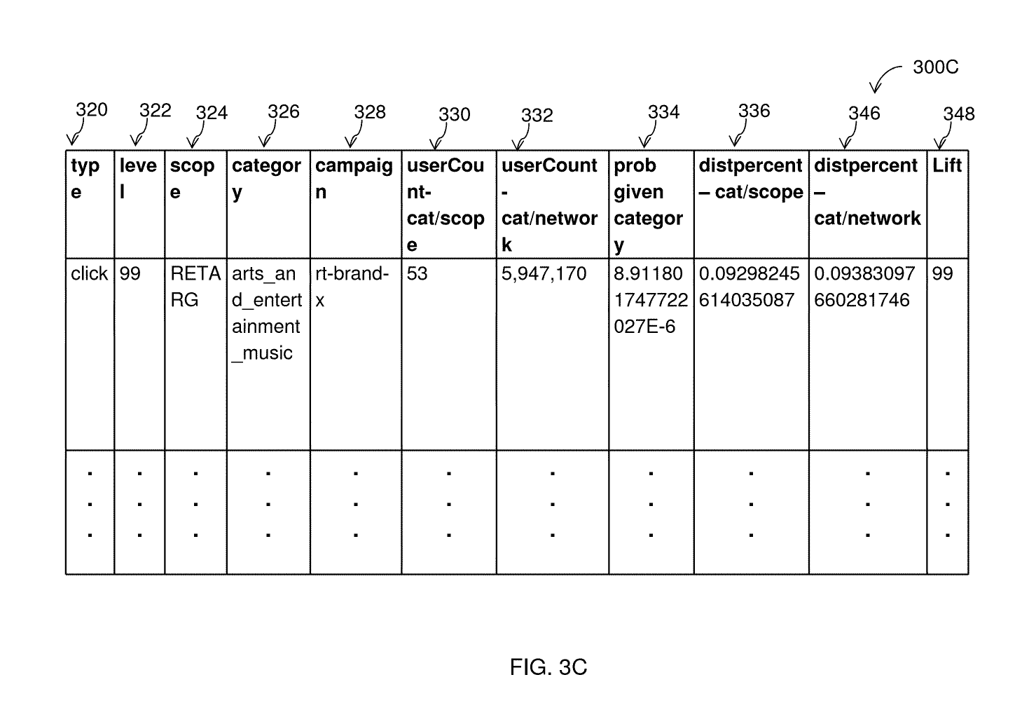

FIG. 3 shows a flowchart 300 illustrating a method for generating one or more reports, in accordance with an embodiment. FIG. 3 will be explained in conjunction with FIG. 1 and FIG. 2.

At method step 302, log records are received from the tracking component 116 and stored in the tracking log data 232 by the tracking application module 210. Information captured in the logs include, but is not limited to, timestamp of the event, user behavior event type (e.g., sharing a page, clicking back on a shared page, viewing a page, search clicking a page), tracking widget type/version, user first-party cookie, user third-party cookie, the social channel, the publisher domain, the page URL, the domain hash, the URL hash, and/or the like. In an embodiment, the tracking component 116 corresponds to a social optimizing pixel or retargeting pixel.

In an embodiment, the method step 302 includes categorizing the content on each of the plurality of web pages into one or more content categories. The content categorization module 228 gathers data from the tracking log data 232 and categorizes the content on each of the plurality of web pages into one or more content categories based on the log records. The content categorization module 228 stores the categorized content as the content categorization data 242.

At step 304, the user mapping module 212 determines the first mapping between preferably each of the plurality of users and the user features on each of the plurality of web pages based on the corresponding user activity. The tracking log data 232 stores cookies corresponding to preferably each of the plurality of users.

In an embodiment, the first mapping is based on the corresponding user activity and the content category amongst the one or more content categories. Further, the first mapping is stored as the user model in the user activity data 234. In the embodiment, the tracking log data 232, the user activity data 234, and the content categorization data 242 are collected over a period of 30 days.

In the following example, the user model specifies the user cookie as a key (for example, 048AA00A176C6E4EC53EXXXXXXX). The user event may be represented as “share”. The content categories (such as, “social_cultural_family_parenting” and “education”) are associated with weights specifying a degree to which the shared pages are associated with the content categories. The content taxonomy can be arranged into different levels of granularity, ranging from low-level topics and key words to high-level categories. “Level0” is an example of a more granular content level, including topics such as “child”, “bullying”, and/or the like.
048AA00A176C6E4EC53EXXXXXXX share{“id”:“048AA00A176C6E4EC53E553302EB7597”,“time”:2012022317,“topic_col”:{“TopicLevel99”:{“topics”:[{“time”:2012022317,“word”:“social_cultural_family_parenting”,“wt”:“83.292”},{“time”:2012022317,“word”:“education”,“wt”:“69.302”}],“level”:99},“TopicLevel0”:{“topics”:[{“time”:2012022317,“word”:“child”,“wt”:“0.362”},{“time”:2012022317,“word”:“bullying”,“wt”:“0.221”},{“time”:2012022317,“word”:“signs”,“wt”:“0.226”},{“time”:2012022317,“word”:“child_school”,“wt”:“0.076”},{“time”:2012022317,“word”:“bullied”,“wt”:“0.038”}],“level”:0},“TopicLevel1”:{“topics”:[{“time”:2012022317,“word”:“child”,“wt”:“0.362”},{“time”:2012022317,“word”:“bullying”,“wt”:“0.221”},{“time”:2012022317,“word”:“child_school”,“wt”:“0.076”},{“time”:2012022317,“word”:“warning_signs”,“wt”:“0.030”},{“time”:2012022317,“word”:“bullied”,“wt”:“0.038”}],“level”:1}},“modelnum”:2}

At step 306, the log record is received from the advertising server 108. In an embodiment, the tracking component 116 corresponds to a tracking pixel embedded into the advertisements of an advertiser campaign. The tracking pixel is added on an advertisement for tracking a plurality of ad impressions and clicks of the users visiting the web pages 114. The ad impressions may be logged by advertising server 108. The log records are received by the web analytic server 102 and stored in tracking log data 232.

At step 306, in another embodiment, the log record is received from the advertiser's domain web server 104. In this case, the tracking component 116 corresponds to a retargeting pixel placed on the advertiser's web site. The retargeting pixel tracks every visit to the web page with the pixel on the advertiser's web server. The retargeting log records are received by the web analytic server 102 and stored in tracking log data 232.

At step 308, the user-campaign mapping module 214 determines a second mapping between the cookies and the advertiser campaign descriptors, including impression, click, and retargeting information. The user campaign data 236 aggregates user campaign-related data over a specified time period.

In the following illustration, a cookie “048AA00A0009224EE13CD6140XXXXX” has been exposed to “advertiser_camp1” 10 times, has clicked on the ads once, has visited the advertiser's landing page 4 times, and has engaged with the ad socially twice. For the cookie, the user has visited advertiser2's landing page 5 times, but has not been exposed to the advertiser's campaign.
048AA00A0009224EE13CD6140XXXXX{“campaigns:{“cmpgn”:“advertiser_camp1”,“socialcnt”:“2”,“imprcnt”:“10”,“clkcnt”:“1”,“retargcnt”:“4”},{“cmpgn”:“advertiser2”,“socialcnt”:“0”,“imprcnt”:“0”,“clkcnt”:“0”,“retargcnt”:“5”}]

At step 310, the first mapping from 304 and the second mapping from 308 are merged together by the merging module 216. According to an embodiment, the merging module 216 merges the user model determined by the user mapping module 212 at step 304 and the advertisement campaign model determined by the Ad-campaign mapping module 214 at step 308. The merged data model is stored in the user activity data 234. The first mappings and the second mappings are joined by the cookies.

At step 312, the analysis module 220 analyzes and segments the merged data model and removes redundant data records, if any. In accordance with an embodiment, the analysis module 220 determines a plurality of audience segments and stores an aggregate number value corresponding to each audience segment. The aggregate number value is the count of unique user cookies in each audience segment. The audience segments can be defined by one or more user features or targets.

As an illustration, FIG. 3A shows a table 300A comprising different types of counts collected for the user segments. The table 300A include a column 320 labeled as “type” that corresponds to a type of user action, e.g. click. A column 322 labeled as “level” corresponds to a numeric level of content category, for example, level 99. A column 324 labeled as “scope” specifies the scope within which the counts are computed. The scope values can include “network” (over the network), “retarg” (specific to a retargeting pixel), or “viewer” (specific to a campaign), etc. A column 326 labeled as “category” corresponds to a content category for the specified level in column 322. A column 328 labeled as “campaign” specifies the name of the advertiser campaign or retargeting corresponding to the scope of the advertiser campaign. A column 330 labeled as “count”, corresponds to a number of unique users. For example, the number of unique users for the “rt-brand-x” retargeting audience who have clicked pages labeled with the “art_and_entertainment_music” category is 53. Similar aggregated numbers can be computed for different user event types, user categories, retargeting audience, campaign viewer, clicker, and conversion audiences, and combinations of these audiences.

In yet another embodiment, the analysis module 220 calculates some additional statistics with respect to given targets of interests, such as retargeting and advertisement campaign descriptors. The additional statistics may include, but are not limited to, a ratio of unique clickers to total unique viewers, a ratio of number of clicks to total advertisement impressions, a ratio of visitors to unique viewers or a ratio of conversions to unique advertisement impressions.

FIG. 3B illustrates another exemplary statistics chart computed by the analysis module 220 in accordance with an embodiment. As an illustration, FIG. 3B shows a table 300B comprising some derived statistics based on the aggregated numbers in FIG. 3A. The table 300B includes a column 320 labeled as “type” that corresponds to a type of user action (e.g. a click). A column 322 labeled as “level” corresponds to a numeric level of content category, for example, level 99. A column 324 labeled as “scope” specifies the scope within which the counts are computed. The scope values can include “network” (over the network), “retarg” (specific to a retargeting pixel), “viewer” (specific to a campaign), etc. A column 326 labeled as “category” corresponds to a content category for the specified level in column 322. A column 328 labeled as “campaign” specifies the name of the advertiser campaign or retargeting corresponding to the scope of the advertiser campaign. A column 332 labeled as “User Count for Cat/Scope” corresponds to the number of unique users who have engaged with the specified category within the audience scope. A column 334 labeled as “UserCount for scope” corresponds to the number of unique users who belong to the scoped audience. A column 336 labeled as “distribution” corresponds to a distribution metric of a category of audience.

FIG. 3B illustrates the calculation of the distribution of an audience engaged with a specific interest category against the entire audience by the analysis module 220, in accordance with an embodiment. As an illustration, given a target audience of “rt-brand-x” audience, row 340 illustrates the stats used for calculating the distribution of “rt-brand-x” retargeting audiences who clicked web pages labeled with “arts_and_entertainment_music” category against the entire “rt-brand-x” audience who clicked web pages corresponding to a plurality of pre-defined categories including the “arts_and_entertainment_music” category. There are 570 unique users in the retargeting audience (i.e., audience scope being “RETARG”) for the campaign “rt-brand-x” who have clicked on web pages corresponding to a plurality of pre-defined categories including the “arts_and_entertainment_music” category. Out of these users, there are 53 unique users in the retargeting audience who have clicked content related to the “arts_and_entertainment_music”. The distribution equals 53/570, or 0.092982. As another example, row 342 illustrates the stats used for calculating the distribution of “rt-brand-x” retargeting audiences who clicked pages labeled with “travel” against the entire “rt-brand-x”. Again, there are 570 unique users in the retargeting audience for the campaign “rt-brand-x” who have clicked on web pages corresponding to a plurality of pre-defined categories including the “travel” category, out of whom 12 unique users have clicked content related to the “travel”. The distribution equals 12/570, or 0.021053. As another example, row 344 illustrates the stats used for calculating the distribution of audiences who clicked pages labeled with the “arts_and_entertainment_music” category against the entire network audience who have clicked on web pages corresponding to a plurality of pre-defined categories including the “arts_and_entertainment_music” category. Over the network, 63,381,734 unique users have clicked, out of whom 5,947,170 unique users have clicked on content related to the “arts_and_entertainment_music” category. The distribution equals 5,947,170/63,381,734, or 0.093831.

In yet another embodiment, FIG. 3C illustrates a table 300C corresponding to an index statistic that captures differences between the network distributions and the distributions of a particular target audience computed by the analysis module 220, in accordance with an embodiment. The table 300C includes a column 320 labeled as “type” that corresponds to a type of user action e.g. click. A column 322 labeled as “level” corresponds to a numeric level of content category, for example, level 99. A column 324 labeled as “scope” specifies the scope within which the counts are computed. The scope values can include “network” (over the network), “retarg” (specific to a retargeting pixel), “viewer” (specific to a campaign), etc. A column 326 labeled as “category” corresponds to a content category for the specified level in column 322. A column 328 labeled as “campaign” specifies the name of the advertiser campaign or retargeting corresponding to the scope of the advertiser campaign. A column 330 labeled as “userCount-cat/scope” records the number of unique users who have engaged with the specified category in the target-scoped audience. A column 332 labeled as “userCount-cat/network” records the number of unique users who have engaged with the specified category in the entire network. A column 334 labeled as, “prob given category”, records the probability of a user belonging to the target audience when the user has engaged with the specified category. A column 336 labeled as “distpercent-cat/scope”, records the percentage of users who have engaged with the specified category among the target audience users. A column 346 labeled as “distpercent-cat/network” records the percentage of users who have engaged with the specified category among the entire network users. In other words, the calculation of the distribution of a category audience who clicked pages with the label, “arts_and_entertainment_music”, against the entire network audience is as follows:

dist(network_category(j))=(count(category(j)))/(count(network))

where count(network) represents the number of unique users in the network; count(category(j)) represents the number of unique users who have clicked on content related to the category j, e.g., in the illustration “arts_and_entertainment_music”. A column 348 labeled as, “Lift”, corresponds to an index. In an embodiment, the index of a category(j), for a target audience i.e. target(i), is computed as the ratio between two distributions. Considering the network as 100, if the index is greater than 100, then the category(j) is over-represented for the target(i) as compared with the network. If the index is lower than 100, then the category(j) is under-represented for the target(i):

index(category(j))=100*(dist(target(i)_category(j))/dist(network_category(j))

For the “rt_brand-x” retargeting audience, the index is (53/570)/(5,947,170/63,381,734), or 99, which shows that the “arts_and_entertainment_music” category audience is a little under-represented compared with the category audience representation in the whole network. The raw counts 53,570, 5,947,170, 63,381,734 can be retrieved from the table illustrated in FIG. 3B.
In another embodiment, FIG. 3C illustrates another derived metric computed based on the base counts in FIG. 3A. The probability 334 of a given target, given a particular audience type belonging to category, can be computed as follows:

Prob(category(i)_target(j))=(count(category(i),target(j)))/(count(category(i)))

For “rt-brand-x”, the probability of a user visiting the brand's website given the user clicking on a page associated with the “arts_and_entertainment_music” category is 53/5,947,170, or 8.911801747722027E-6.

In yet another embodiment, the ranking module 224 ranks the plurality of audience segments determined by the analysis module 220 at step 312 based on one or more metrics. The plurality of audience segments comprises a plurality of user profiles in each of the plurality of audience segments. The one or more metrics include, but are not limited to, a number of users visiting one of the plurality of web pages, overall user traffic at the web page, a ratio of number of users visiting the web page for a search keyword to the total number of users visiting the web page, and a click-through rate. In another embodiment, the ranking module 224 ranks the retarget data model as determined by the analysis module 220.

At step 314, the report generation module 222 generates one or more reports for the advertising server 108 and stores the one or more reports in the report data 238. During one or more stages of the advertisement campaign, the one or more reports can be retrieved by the advertising server 108 from the report data 238. In an embodiment, the one or more reports comprise a user profile report, a segment profile report, and a retarget user profile report.

FIG. 4 illustrates a plurality of reports 400 generated during the different stages in a sales cycle: request-for-proposal (RFP) 402, pre-campaign 412, in-campaign 422, and post-campaign 432.

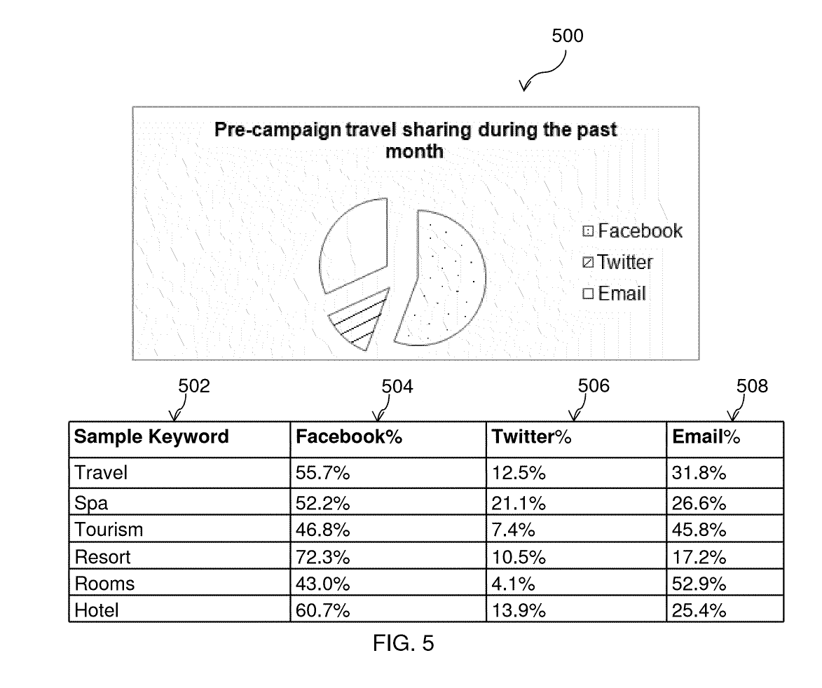

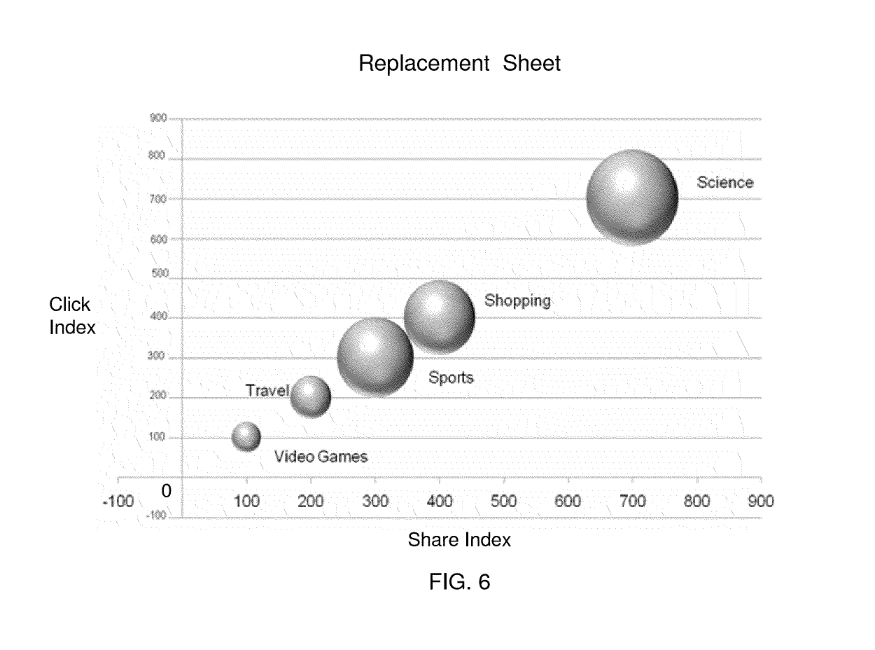

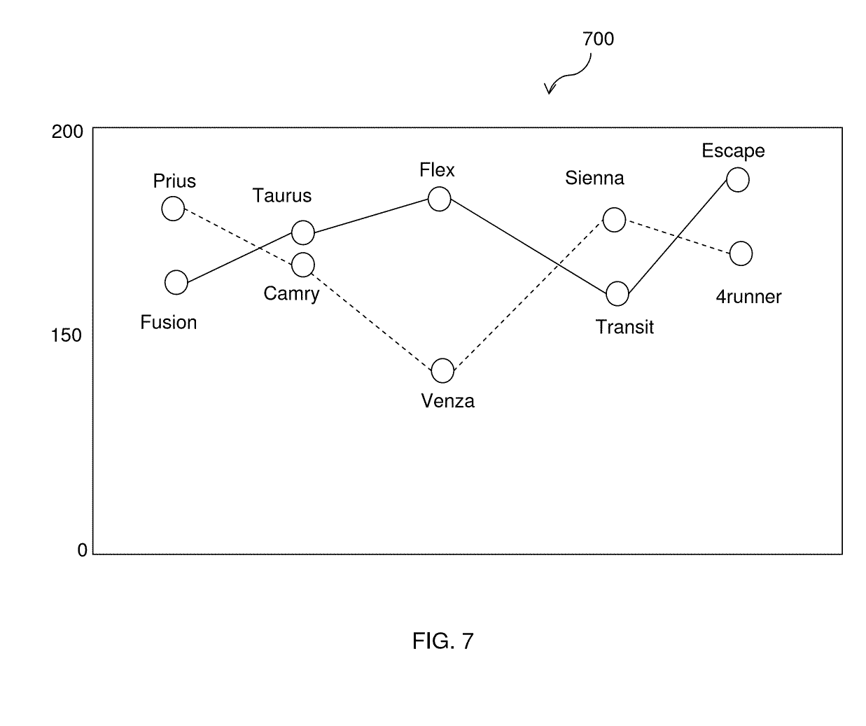

FIG. 4A illustrates a plurality of reports generated during the RFP stage of an advertising campaign, in accordance with an embodiment. Advertisers may provide a plurality of campaign objectives for an advertisement campaign. These objectives may be in the form of a plurality of campaign requirements or campaign descriptors to the web analytic server 102. The advertisement requirements may be in the form of an RFP. Other forms of receiving advertisement requirements may include emails, client meetings, and/or the like. An RFP stage report 402 is prepared for understanding social behavior of a target audience of the advertisement campaign. The plurality of reports include, but are not limited to, a first RFP stage report 404, a second RFP stage report 406, a third RFP stage report 408, and a fourth RFP stage report 410. These reports are generated by the web analytic server 102. According to an embodiment, the fourth RFP stage report 410 corresponds to an industry benchmark report that gives a summary of user profiles visiting high social-index sites for an advertisement category. Examples of the first RFP stage report 404, the second RFP stage report 406, and the third RFP stage report 408 are discussed in detail below with reference to FIG. 5, FIG. 6, and FIG. 7 respectively.

Returning to FIG. 3, at step 314, report generation module (222 of FIG. 2) generates one or more pre-campaign stage reports 412 in an embodiment. The one or more pre-campaign stage reports 412, as illustrated in FIG. 4B, gives the advertising server 108 a precise insight into their preferred target audience prior to embarking on an advertisement campaign. This enables the advertising server 108 to identify and build a detailed user profile of their target audience, and then design an online campaign to best engage the target audience.

The user profile is completely anonymous and is based on users' previous online behavior. This information empowers the advertising server 108 with actionable data to use at the planning and brainstorming stage of the advertisement campaign to target specific audience groups.

In an embodiment, the online behavior of the advertiser-preferred users is captured by the retargeting pixel on the web pages and stored in the user activity data 234. The retargeting users can be profiled based on their behavior activities on the network (such as share interests, search keywords, domains visited, etc.) and their behavior response. Based on the discriminating characteristics of the advertiser-preferred users, additional audiences previously unidentified by the advertisers can be extracted.

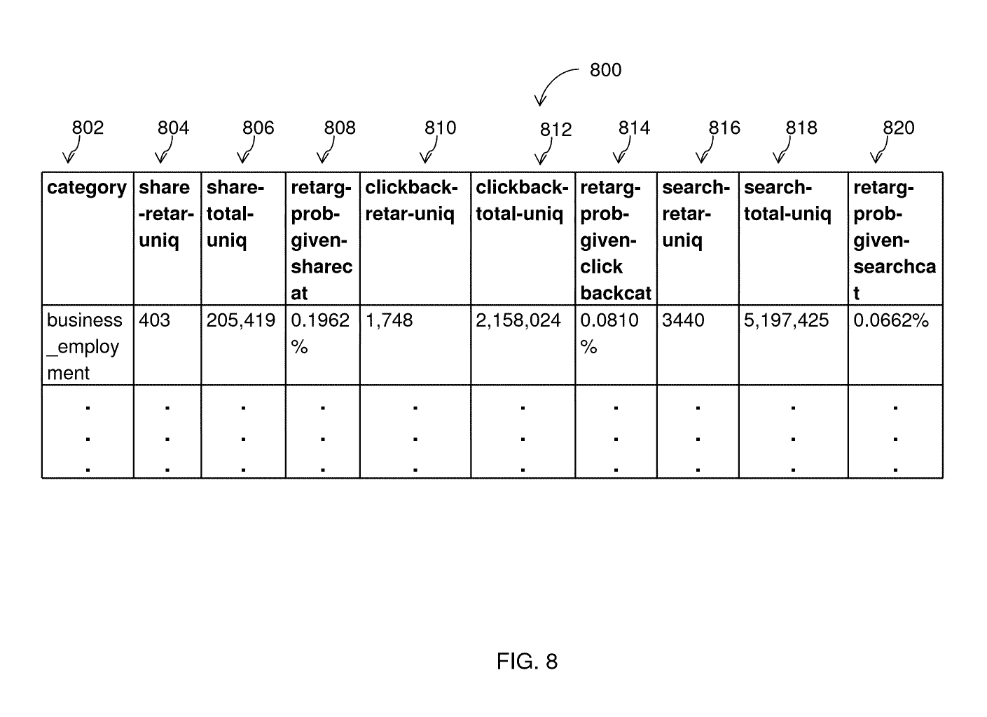

Referring to FIG. 4B, a first pre-campaign stage report 414 is generated in an embodiment. The first pre-campaign stage report 414 may be a probability report of conversion that reflects a probability of conversion of a retarget audience across one or more categories for different user event types, such as share, click, search, or regular page view as shown in FIG. 8. Similar probability reports can be produced for site visits, searches, and/or the like.

In another embodiment, the step 314 of FIG. 3 may also include the generation of a second pre-campaign stage report 416 as illustrated in FIG. 4B. The second pre-campaign stage report 416 may include keywords associated with content searched by users and their correlation with a target audience based on a probability measure.

In yet another embodiment, the step 314 of FIG. 3 may also generate a third pre-campaign stage report 418 that may include keywords associated with the content shared or clicked and their correlation with a retarget audience based on a probability measure.

In another embodiment, post-campaign stage reports 432, as illustrated in FIG. 4C, provide the advertising server 108 with key teachings and evaluations from the advertisement campaign, suggesting actionable steps to implement in a future advertisement campaign. The post-campaign stage reports 432 enables the advertising server 108 to gain an improved understanding of how the campaign achieved results and provides future targeting and marketing insight into target audiences.

Further, the post-campaign stage reports 432 may include a first post-campaign stage report 434 and a second post-campaign stage report 436, in accordance with two further embodiments. The first post-campaign stage report 434 may show a comparison of audience interest to ad-exposure distribution against audience profile and also include share/clicks on ads.

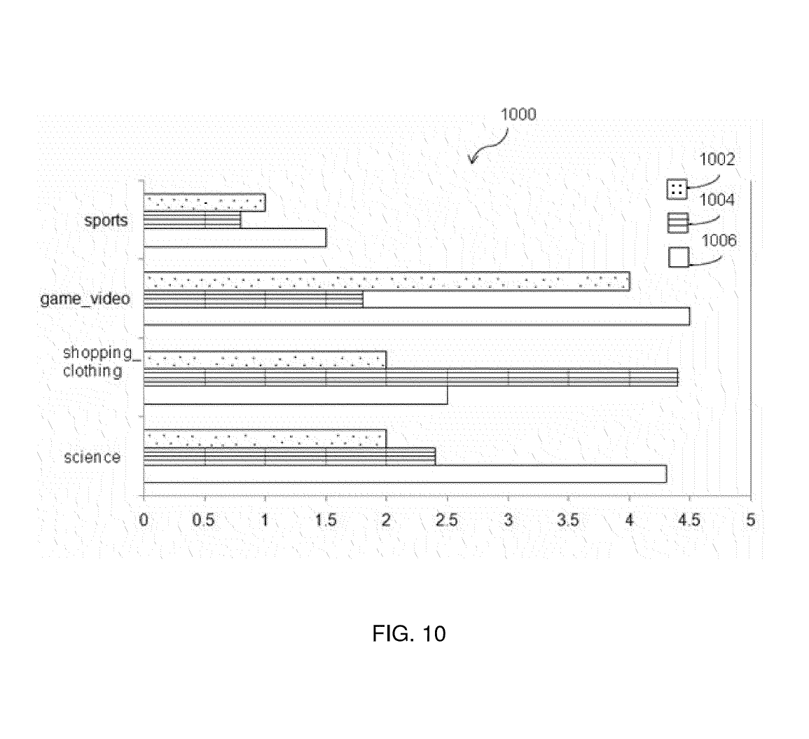

More specifically, the first post-campaign stage report 434 receives a plurality of retargeting campaigns as input. The first post-campaign stage report 434 uses indices to provide a comparison of user interests to ad-exposure metrics against the user profile. To enhance the campaign effectiveness, users who have shown a prior interest in the products or services of the advertising server 108 may be selected for the set of exposed users. An example of the first post-campaign stage report 434 is discussed in detail with reference to FIG. 10.

The second post-campaign stage report 436 may show keywords profile of searched content of ad-exposed audience. The second post-campaign stage report 436 receives a plurality of campaign viewers as input and provides a search keywords profile of the campaign viewers. In one embodiment, for a given keyword, the report records the number of unique users who have searched for content related to the keyword and the number of unique users among the viewers who have searched for content related to the keyword. Such a report can be compared with the pre-campaign search keyword profile report 416 to illustrate the similarities and differences in search interests pre- and post-campaign. This can provide insight on the ad exposure effect of the campaign in terms of users' search interest.

In another embodiment, periodic reports are generated by the report generation module 222 of FIG. 2. With reference to FIG. 3, at the step 314, the profile generation module generates periodic reports as and when the advertising server 108 requires them. Periodic reports are not stage-specific. Therefore the periodic reports can be retrieved at any time by the web analytic server 102 as required by the advertising server 108. Some instances of periodic reports may be a channel breakdown per category report, a top keywords per level category report, a top growth/loss keywords report and a channel breakdown of the keywords report for a specific time period.

FIG. 5 illustrates an exemplary report 500 of the first RFP stage report 404, depicting share distribution of an advertisement campaign's related keyword topics. The exemplary report 500 includes a pie chart that is generated by the report generation module 222, which report corresponds to share channel distribution of an advertisement campaign category (e.g. travel, automotive, and/or the like.). A column 502 labeled as “Sample Keyword” corresponds to a keyword associated with an advertisement campaign category, for example, “Travel”. A column 504 labeled as “Facebook %” corresponds to the share channel distribution of Facebook®, for example, “55.7%”. A column 506 labeled as “Twitter %” corresponds to the share channel distribution of Twitter®, for example, “12.5%”. A column 508 labeled as “Email %” corresponds to the share channel distribution of email of a specific site, for example, “31.8%”. The spreadsheet provides detailed user interests or topics related to the advertisement campaign across social networking channels over a specified time period. The first RFP stage report 404 may be used by the advertising server 108 to determine which social channels produce the highest level of online user activity for the advertiser campaign related categories or topics.

FIG. 6 illustrates an exemplary report 600 of the second RFP stage report 406 depicting an earned media profile. The exemplary report 600 is a content category report that is generated by the report generation module 222, wherein is described a target audience by using a list of keywords or a retargeting audience. The exemplary report 600 demonstrates an earned media potential for the advertisement campaign using share and click-back indices. The share index (X-axis) and click-back index (Y-Axis) represent the comparison of degrees of sharing and clicking-back activities of the users to some pre-determined benchmarks (e.g., network benchmarks or vertical benchmarks). As illustrated in FIG. 6, the earned-media profile report shows bubbles corresponding to a specific audience segment of a specific content category, for example, “Video Games”, “Travel”, “Sports”, “Shopping”, and “Science”. The size of the bubble represents the size of the corresponding audience segment. High share and click-back indexes corresponds to high earned media profile.

FIG. 7 illustrates an exemplary report 700 of the third RFP stage report 408 depicting a product/brand comparison index. The exemplary report 700 is a comparison report that is generated by the report generation module 222, which report uses a list of keywords representing a product or brand and its competition. The exemplary report 700 shows a comparison between a product (or brand) and its competitors, based on social buzz. The social buzz corresponds to volume of shares and click-backs on a network 106 over the past 30 days. An index may be used for comparison. The comparison index of various products is computed by using the share and click-back activity of the users. In an embodiment, the report can be used by an advertising server 108 to determine how their product has been engaged socially vis-a-vis multiple competitors. For example, users' shares and click-backs over a pre-determined number of days computes indices of various products represented by keywords (for example, “Prius”, “Camry”, “Venza”, “Sienna” and “4runner” for the car maker Toyota) in the exemplary report 700. The Y-axis represents the volumes of shares and click-backs of the various products/brands represented by keywords. The dashed line links the various product keywords together to produce an overall view of the car brands by Toyota. The solid line links the various product keywords representing competitors' products, presenting an overall view of the competitors' social buzz. When the two lines are viewed together, one can get an idea of a brand or product of interest compared with its competitors.

FIG. 8 illustrates a statistics report 800 of the different events types and descriptors across various content categories. The statistics report 800 illustrates an example of the first pre-campaign stage report 414. The statistics report 800 illustrates a probability report of conversion that corresponds to an “L99 content category” for an advertiser website. L99 represents one of the many levels of content categories ranging from L0 to L99, L99 being the top level content category. The statistics report 800 includes a column 802 labeled “category” that stores a name of the content category (e.g. “business_employment”). The column 802 could be used to represent content at other category levels, based on the category taxonomy. The statistics report 800 also includes three sets of columns representing three different online activities of the user (i.e. share, clickback and search). The user activities are interrelated with a target audience (e.g., the retargeting audience). As already mentioned, the retargeting pixel is placed on one or more landing pages of the advertiser's website. The retargeting audience is extracted from the retargeting logs, and their online behaviors may be retrieved from the user activity data, e.g. unique and total occurrences of shared keywords, click-backs or search terms across certain content categories may be captured for the target audience. The shared keywords, click-back terms and search topics extracted from the content utilized/viewed by the users provide insight into what products or services the user is looking for online.

The statistics report 800 further includes columns 804, 810 and 816 labeled as, “share-retar-uniq”, “clickback-retar-uniq”, and “search-retar-uniq”, respectively. The columns represent the numbers of unique users in the target audience (e.g., the retargeting audience) who have shared, clicked, or searched content across different categories or topics, for example, “403”, “1748”, and “3440” respectively for the given “business_employment” category. Columns 806, 812 and 818 represent the numbers of unique users who have shared, clicked, or searched content on the entire network across different categories or topics, labeled as, “share-total-uniq” (for example “205,419” for the “business_employment” category), “clickback-total-uniq” (for example “2,158,024” for the “business_employment” category), and “search-total-uniq” (for example “5,197,425” for the “business_employment” category), respectively. Columns 808, 812 and 820 represents a percentage for the set of three online user activities, labeled as “retarg-prob-given-sharecat”, “retarg-prob-given-clickbackcat”, “retarg-prob-given-searchcat”, reflecting a probability that the user be a retargeting user given the user has shared, clicked, or searched content related to the given category (for example “0.1962%”, “0.0810%”, and “0.0662%” respectively).

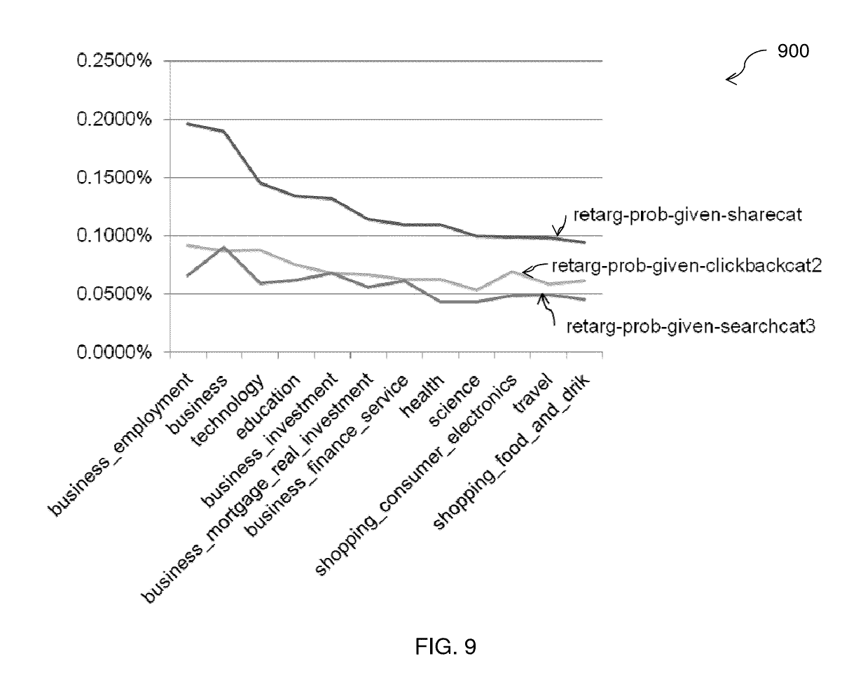

FIG. 9 illustrates a report 900 showing a probabilistic measure of event occurrence across the various content categories. The distribution report 900 is a pictorial representation of the columns 808, 814 and 820 in FIG. 8. The X-axis represents the category dimension. The Y-axis represents the probability dimension. The three curved lines represent the probabilities for the categories for each event types (share, click-back, and search).

FIG. 10 illustrates an exemplary post-campaign stage report 1000 depicting viewer/segment lift (or conversion). The exemplary post-campaign stage report 1000 illustrates a first post-campaign stage report 434. The exemplary report 1000 compares three audience segments for the advertiser campaign namely, ad clicker/player (labeled as 1002), advertiser visitors/retargeting users (labeled as 1004), and ad viewers (labeled as 1006) for one or more categories (for example, “sports”, “game_video”, “shopping_clothing”, or “science”). The Y-axis specifies the categories related to the user segments. The X-axis specifies the index of the audiences for the different categories. The index is a ratio between the proportions of users interested in a specified category for an audience population compared with the proportion of users interested in a specified category for the network population. The higher the index for a particular category, the higher concentration of users with interest in that category for the specified audience. The network average is set to 1. Report 1000 compares three audience segments simultaneously and gives insights on how the campaign delivers and performs. For example, for the “game_video” category, the retargeting audience segment is moderately higher indexed, while the campaign viewer segment and the campaign clicker segment are more highly indexed for the category. For the “shopping_clothing” category, the retargeting audience segment is more highly indexed for the category, while the campaign viewer segment and the campaign clicker segment are moderately indexed for the category.

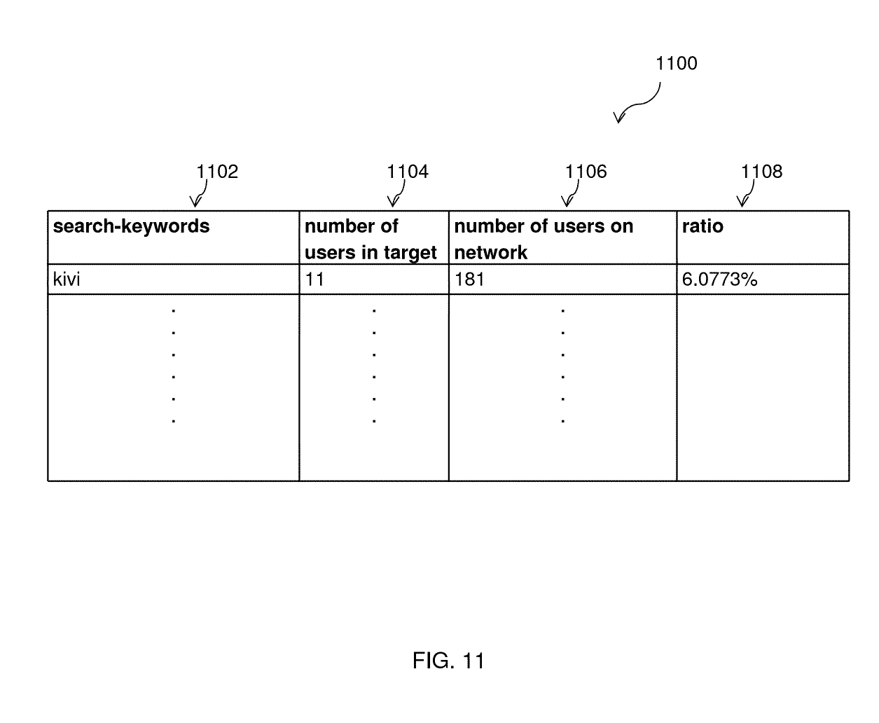

FIG. 11 illustrates a search-keyword report 1100 for a given target audience, according to one embodiment. The search interest profile report 1100 includes search interest keywords and various metrics. The report 1100 includes column 1102 labeled “search-keywords”, denoting keywords associated with the searched content of the users. The keywords are extracted from the content of the landing pages after users have searched for certain topics and landed on the clicked pages. The keywords are associated with users in user activity data 234. Column 1104 labeled “number of users in target” records the number of unique users in the target audience with the specified keyword interest in column 1102. Column 1106 labeled “number of users on network” records the number of unique users in the network with the specified keyword interest in column 1102. Column 1108 labeled “ratio” illustrates the percentage of users in the target audience who have the keyword interest in column 1102 with respect to the pool of the network users who have the keyword interest in column 1102. For example, 181 users have searched for content related to the keyword, “kivi”. Eleven of them are also found in the target audience. For the keyword, “kivi”, the percentage of users in the target audience who are associated with the keyword in the search content consumption compared with all the users who have searched for content associated with “kivi” is 6.0773%. By varying the target audience, campaigns may use such search interest profiles for planning audiences for targeting pre-campaign, for optimization in-campaign, or for analysis post-campaign.

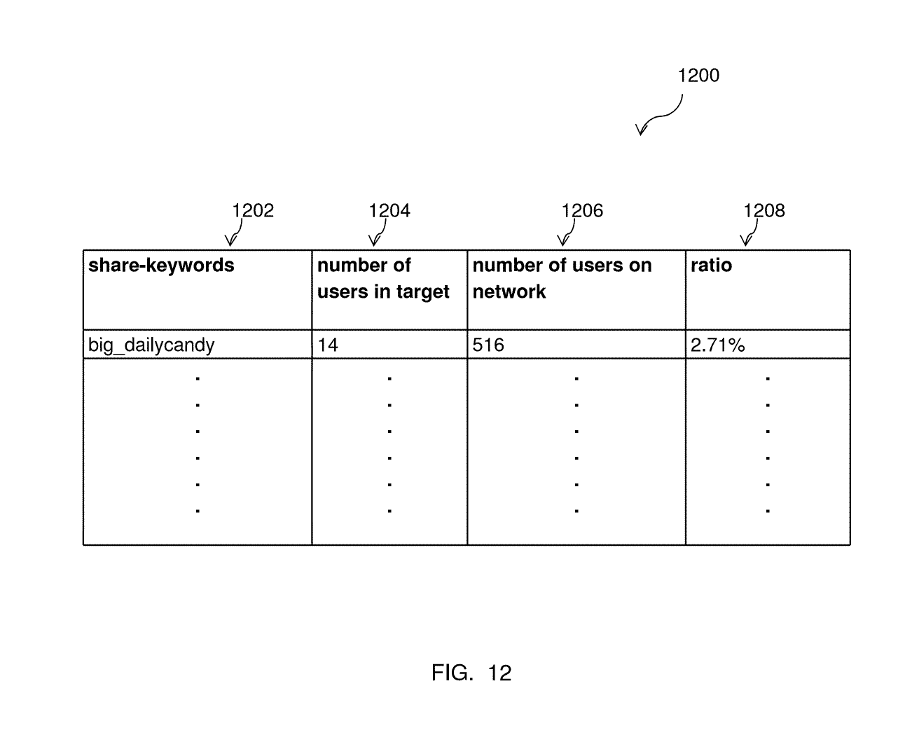

FIG. 12 illustrates a share-keyword audience profile report 1200 showing a plurality of share keywords and corresponding metrics for a given target audience, in accordance with another embodiment. The target audience can be any audience defined by the campaign, such as defined by a set of campaign related keywords, pixel audience, campaign viewers, advertiser converters, to name a few. The share-keyword report 1200 includes a column 1202 labeled “share-keywords” for storing keywords associated with the content shared by one or more users, for example “big_dailycandy”. The share-keywords are received from the tracking log data 232 and are associated with the users in user activity data 234. A column 1204 labeled “number of users in target” records the number of unique users in the specific target audience, for example “14”, who have shared content with the specified keyword in the column 1202. A column 1206 labeled “number of users on network” records the number of unique users on the whole network, for example “516” who have shared content with the specified keyword in the column 1202. A column 1208 labeled “ratio” illustrates the proportion of target audience against the network audience for a given share-keyword, for example “2.71%”. The ratio gives an indication of what keywords are socially shared more for the target audience with respect to the network audience. It provides a social profile of the target audience. By varying the target audience, campaigns can use such social profiles for planning audiences for targeting pre-campaign, for optimization in-campaign, or for analysis post-campaign.

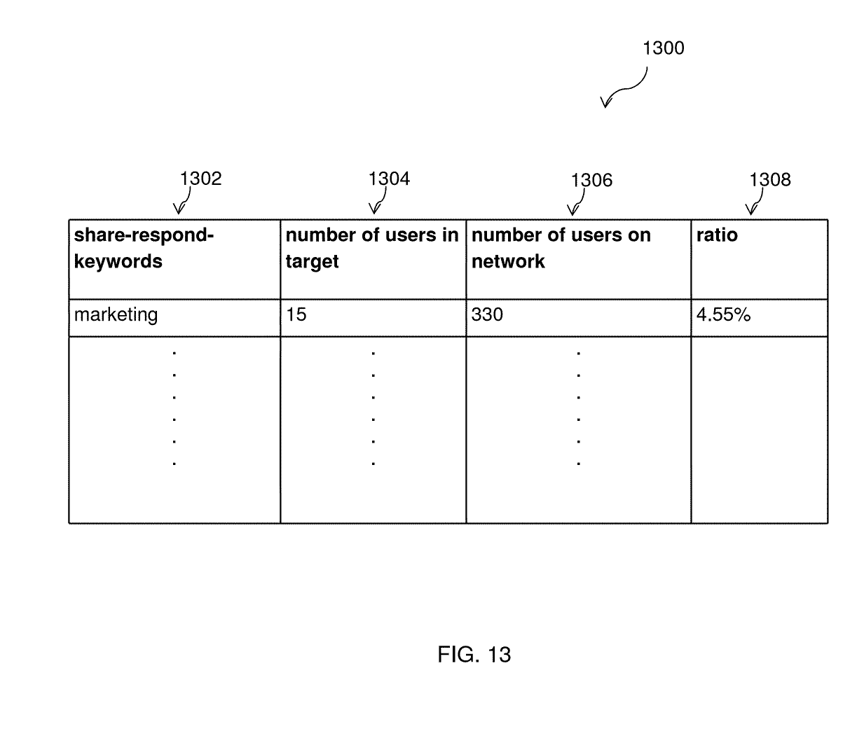

FIG. 13 illustrates a share-respond-keyword report 1300, showing a plurality of share respond keywords and corresponding metrics for a given target audience, in accordance with another embodiment. The target audience can be any audience defined by the campaign, such as defined by a set of campaign related keywords, pixel audience, campaign viewers, advertiser converters, to name a few. The share-respond-keyword report 1300 includes a column 1302 labeled “share-respond-keywords” for storing share respond keywords, for example “marketing”. Share-respond keywords correspond to the keywords extracted from content first shared by one or more users and then clicked by one or more users. The share-respond keywords are received from the tracking log data 232 and they are associated with the users in user activity data 234. A column 1304 labeled “number of users in target” records the number of unique users in the specific target audience, for example “15”, who have clicked on content with the specified keyword in column 1302. A column 1306 labeled “number of users on network” records the number of unique users on the whole network, for example “330” who have clicked on content with the specified keyword in column 1302. A column 1308 labeled “ratio” illustrates, for a given share-respond keyword, the proportion of target audience against the network audience, for example “4.55%”. The ratio is an indication of what keywords are clicked for the target audience with respect to the network audience. It provides a social profile of the target audience. By varying the target audience, campaigns can use such social profiles for planning audiences for targeting pre-campaign, for optimization in-campaign, or for analysis post-campaign.

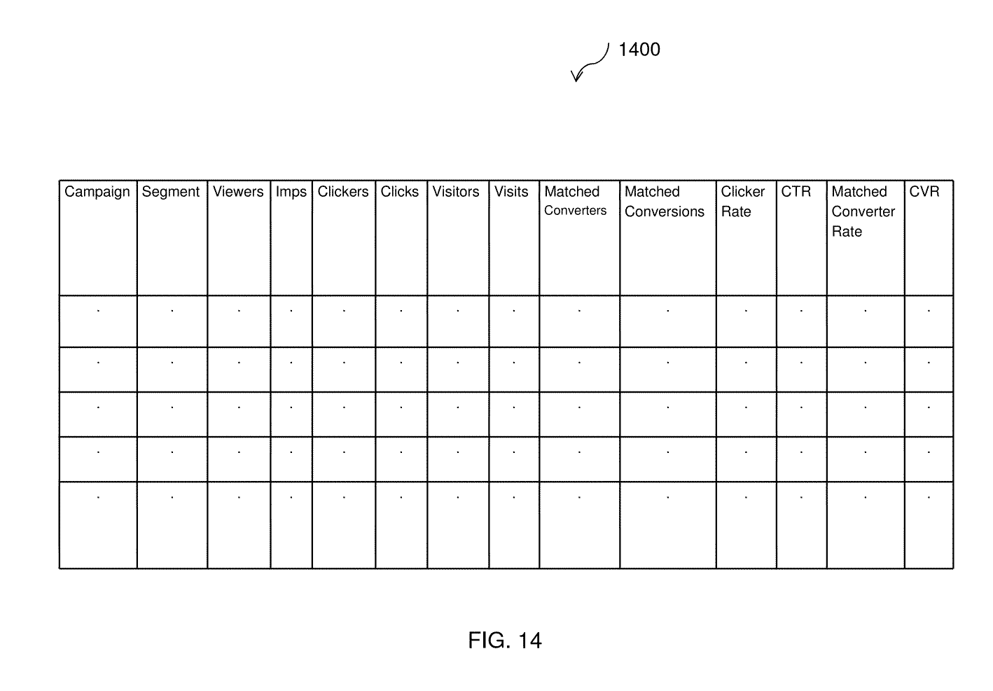

FIG. 14 illustrates an exemplary campaign-descriptor report template 1400, which describes various numbers related to an advertiser or campaign. The “Campaign” column records the campaign name. The “Segment” column records the name of an audience segment. The “Viewers” column records the unique number of campaign viewers belonging to the specified audience segment. The “Imps” column records the number of campaign impressions associated with the specified audience segment. The “Clickers” column records the unique number of campaign clickers belonging to the specified audience segment. The “Clicks” column records the number of campaign ad clicks associated with the specified audience segment. The “Visitors” column records the unique number of advertiser page visitors belonging to the specified audience segment. The “Visits” column records the number of advertiser page visits associated with the specified audience segment. The “Matched Converters” column records a unique number of advertiser's converters (or viewers) belonging to the specified audience segment that can be attributed back to the advertising campaign. The “Matched Conversions” column records the number of advertiser conversions (or impressions) associated with the specified audience segment that can be attributed back to the advertising campaign. The attribution may correspond to the “Click-through-conversion” or the “View-through-conversion”. The “Clicker Rate” column is a ratio between column “Clicker” and column “Viewer”. The “CTR” column is a ratio between column “Clicks” and column “Imps”. The “Matched Converter Rate” column is a ratio between column “Matched Converters” and column “Viewers”. The “CVR” column is a ratio between column “Matched Conversions” and column “Imps”. Depending on the data available, the report 1400 can be used during the pre-campaign for selecting audience segments for targeting, in-campaign for optimizing campaign performance, or post-campaign for post-campaign reporting.

In yet another embodiment, the report generation module 222 generates publisher monetization reports during the pre- and post-campaign stages. Publishers currently lack benchmarking tools they need to develop their digital strategies and monetize their content. The publisher monetization report corresponds to a social quality Index (SQI) report reflecting a measure of web-wide sharing activity and providing publishers and advertisers with website rankings across key content categories as specified in the present disclosure.

The disclosed methods and systems, as described in the ongoing description or any of its components, may be embodied in the form of a computer system. Typical examples of a computer system include, but are not limited to, a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, and/or the like. The storage device may also be other similar means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through an input device, accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The programmable or computer readable instructions may include various commands that instruct the processing machine to perform specific tasks such as the steps that constitute the method of the present invention. The method and systems described can also be implemented using only software programming or using only hardware or by a varying combination of the two techniques. The disclosed invention is independent of the programming language used and the operating system in the computers. The instructions for the invention can be written in all programming languages including, but not limited to ‘C’, ‘C++’, ‘Java’, ‘Python’, ‘Visual C++’ and ‘Visual Basic’. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS->Windows’, ‘Android’, ‘Symbian’, and ‘Linux’.

The programmable instructions can be stored and transmitted on non transitory computer readable medium. The programmable instructions can also be transmitted by data signals across a carrier wave. The disclosed invention can also be embodied in a computer program product comprising a computer readable medium, the product capable of implementing the above methods and systems, or the numerous possible variations thereof.

While various embodiments have been illustrated and described, it will be clear that the invention is not limited to these embodiments only. Numerous modifications, changes, variations, substitutions and equivalents will be apparent to those skilled in the art without departing from the spirit and scope of the invention as described in the claims.

While the specification contains many prerequisites; these should not be construed as restrictions on the scope of what being claims or of what may be claimed, but rather as descriptions of features specific to particular embodiments. Certain features that are described in this specification in the context of separate embodiments can also be implemented in combination in a single embodiment. On the contrary, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be eliminated from the combination, and the claimed combination may be directed to a sub-combination or variation of a sub-combination.

Similarly, while operations are depicted in the drawings in a particular order, this should not be understood that such operations are performed in the particular order shown or in a sequential order, or that all illustrated operations be performed, to achieve desirable results. In certain conditions, multitasking and parallel processing may be beneficial. Moreover, the division of various modules in the embodiments described above should not be understood as requiring such division in all embodiments, and it should be understood that the described modules can generally be incorporated together in a single software product or packaged into multiple software products.

Thus, particular embodiments have been described in the disclosure. Other embodiments are within the scope of the following claims.

What is claimed is:

1. A method for generating reports of a plurality of users visiting a plurality of web pages, the method comprising:
extracting a plurality of user features for the plurality of users based on at least one log record;
determining a first mapping between the plurality of users and the plurality of user features, and a second mapping between the plurality of users and a plurality of advertisement campaign descriptors;
merging the first mapping and the second mapping to create a merged data model; and
analyzing the merged data model to generate reports,
the above steps being performed by a computer.

2. The method of claim 1, wherein the at least one log record comprises an anonymous cookie representing one or more of the plurality of users, a click log, a sharing log, a timestamp, an event type, a sharing channel, a content identifier, a universal resource locator (URL), domain information and a browsing pattern of the plurality of users.

3. The method of claim 2, wherein the event type is one or more of sharing through a tracking component, viewing a web page, clicking a web link, visiting a web page and searching for a keyword.

4. The method of claim 1, wherein the plurality of user features comprises a content category associated with at least one of a web page, keywords representing user's interest, sharing activity and total number of visits of the plurality of users to the at least one web page.

5. The method of claim 1, wherein the plurality of advertisement campaign descriptors comprise at least one of a plurality of keywords describing an advertisement campaign, retargeting log records, conversions on an advertiser's website, user response history, and at least one content category associated with the advertisement campaign.

6. The method of claim 5 comprising;
mapping the retargeting log records with the merged data model to create a retarget data model; and
segmenting the retarget data model and creating a plurality of retarget user profiles.

7. The method of claim 1, wherein merging comprises removing redundant records from the merged data model.

8. The method of claim 1, wherein the analyzing comprises creating one or more segments from the merged data model, wherein the creating comprises ranking of the one or more segments based on one or more metrics.

9. A web analytic server for generating reports of a plurality of users visiting a plurality of web pages, the web analytic server comprising:
a user mapping module configured to:
determine a first mapping between the plurality of users and a plurality of user features; and
determine a second mapping between the plurality of users and a plurality of advertisement campaign descriptors;
a merging module configured to merge the first mapping and the second mapping to create a merged data model;
an analysis module configured to segment the merged data model; and
a profile generation module configured to generate reports based on the segmented merged data model.

10. The web analytic server of claim 9 comprising a user mapping module configured to extract the plurality of user features for the plurality of users based on at least one log record.

11. The web analytic server of claim 9, wherein the profile generation module is further configured to generate one or more reports corresponding to one or more stages of an advertising campaign.

12. The web analytic server of claim 9, wherein the profile generation module is further configured to generate retarget user profiles of an advertisement campaign.

13. A non-transitory computer-readable storage medium storing instructions which when executed by a web analytic system cause the web analytic system to segment a plurality of users visiting a plurality of web pages, by:
extracting a plurality of user features for the plurality of users based on at least one log record;
determining a first mapping between the plurality of users and a plurality of user features, and a second mapping between the plurality of users and a plurality of advertisement campaign descriptors;
merging the first mapping and the second mapping to create a merged data model; and
creating one or more segments of users based at least in part on an analysis of the merged data model.

14. The computer-readable storage medium of claim 13, wherein the user features comprise at least one of a content category associated with the at least one web page, keywords representing the user's interest, sharing activity of the user and total number of visits of the user to the at least one web page.

15. The computer-readable storage medium of claim 13, wherein the advertisement campaign descriptors comprise at least one of a plurality of keywords describing the users of the advertisement campaign or the users who have visited the advertisement campaign in the past but were not converted into customers, user's behavioral response descriptors, and at least one content category associated with the advertisement campaign.

16. The computer-readable storage medium of claim 13, wherein the merging comprises aggregating the plurality of records of the plurality of users, the user features and the advertisement campaign descriptors, and removing redundant records from the aggregated records.

17. The computer-readable storage medium of claim 13, wherein the creating comprises ranking of the one or more segments based on one or more metrics.

18. The computer-readable storage medium of claim 17, wherein the one or more metrics comprises one or more of a number of users visiting one of the plurality of web pages, an overall user traffic at the web page, a ratio of number of users visiting the web page for a search keyword to total number of users visiting the web page, and a click-through rate.

19. The computer-readable storage medium of claim 13, wherein the creating comprises generating one or more reports.

20. The computer-readable storage medium of claim 19, wherein the one or more reports comprises at least one of a user profile report, a segment profile report, and a retarget user profile report.
